(19) United States
(12) Patent Application Publication
(10) Pub. No.: US 2026/0138308 A1
(43) Pub. Date: May 21, 2026

(54) METHOD AND DEVICE FOR MELT-IMPREGNATING FIBRES WITH THERMOPLASTIC MATRIX

(71) Applicant: LEIBNIZ-INSTITUT FÜR VERBUNDWERKSTOFFE GMBH, Kaiserslautern (DE)

(72) Inventors: Tobias DONHAUSER, Neustadt (DE); Andreas KENF, Kaiserslautern (DE); Sebastian SCHMEER, Neustadt (DE)

(21) Appl. No.: 18/879,214

(22) PCT Filed: Jun. 27, 2023
(86) PCT No.: PCT/DE2023/100484

§ 371 Date: Dec. 26, 2024

(30) Foreign Application Priority Data
Jun. 28, 2022 (DE) 10 2022 116 096.3

(51) Int. Cl. B29B 11/16; B29C 70/20; B29K 101/12

(52) U.S. Cl. CPC B29B 11/16; B29C 70/20; B29K 2101/12

(57) ABSTRACT

A method and a device for melt impregnation of fibers with a thermoplastic matrix. To provide a method and a device for impregnating dry fibers with a highly viscous thermoplastic matrix, the fibers are guided over a curved, perforated metal sheet as an impregnation line while applying a contact pressure, wherein the highly viscous thermoplastic matrix passes through the perforations of the metal sheet in order to subsequently impregnate the fibers. The metal sheet is not flat, but is integrated into the impregnation unit in a curved shape. By deflecting the fibers, which may be present as fiber bundles or as single fibers, around the curved metal sheet, the necessary contact pressure between the fibers and the plastic supply can be created. The fibers thus move under a longitudinal tensile stress over the perforated metal sheet, creating a sinusoidal contact pressure distribution between the fibers and the metal sheet.

The invention relates to a method and a device for melt impregnation of fibers with a thermoplastic matrix.

Numerous methods for impregnating fibers with a thermoplastic matrix are known. These can be divided into the following groups:

Powder impregnation: The fanned fibers are brought into contact with a powder (e.g. by a fluidized bed or electrostatic dispersion). The powdered fibers are then passed through a heating section and consolidated by means of down-stream cooling rollers to form a fiber-matrix semi-finished product. The main problem with this method is that the grain size of the powder must approximately correspond to the fiber diameter (e.g. about 6 μm for carbon fibers) in order to achieve good impregnation. Procuring polymers at such a fineness is usually associated with high costs and is sometimes technically not possible.

Solvent impregnation: The impregnation is achieved by reducing the polymer viscosity by use of solvents, which diffuse out of the finished semi-finished product again after the impregnation process. This method only works for thermoplastics such as PC, PSU, PES or PEI.

Film impregnation: Fibers and films of plastics are pressed together under heat and pressure. Here, the fiber volume content can be adjusted by varying the number and thickness of the films. This method enables an impregnation of fibers with a very high quality. However, not every plastic is available on the market or can be produced as a film of any thickness, so that this method has limitations in terms of applicability.

Hybrid fiber technology: The reinforcing fibers are spun together with plastic fibers in a mixed roving (also referred to as a mixed yarn or commingled yarn). When the roving is processed, the plastic fiber is melted, thus ensuring the impregnation of the reinforcing fibers. Here, too, it is necessary, as with film impregnation, that the plastic fibers have approximately the same diameter as the reinforcing fibers, since otherwise complete impregnation is not possible.

Melt impregnation: The rovings are drawn from a spool holder, spread and then impregnated with a molten matrix. There are a variety of constructive solutions to liquefy the thermoplastic matrix and ultimately to supply the dry fibers.

Here, the most important process parameters for the production of high-quality fiber-matrix semi-finished products are the viscosity of the melt and the effective impregnation pressure. In order to ensure this functionality, very large systems with the corresponding peripherals are usually necessary, which increases the size of the entire system. As a result, current systems for impregnating fibers with thermoplastics can only be combined to a limited extent with other machines (e.g. production systems for component manufacturing), which limits their field of application.

All these known solutions for melt impregnation have the following disadvantages:

Process control: The impregnation process of fibers becomes more complex with increasing matrix viscosity. In this context, precise temperature and pressure control over the impregnation line is crucial. In existing systems, it is not possible to control the temperature and pressure conditions over the impregnation line in a fine-layered manner, which has a negative impact on the quality of the end product (impregnated fiber semi-finished product, also known as tape).

Waste: The known methods usually result in process-related waste, since impregnation is not possible constantly across the entire width of the tape. In this case, a fiber semi-finished product is impregnated over a large area in a continuous process. Edge areas with different cavity conditions and thus impregnation qualities are usually cut off afterwards.

Construction: Conventional systems do not allow for a compact construction and thus enable only a limited integration of the technology into existing automation systems (e.g. as an attachment for an industrial robot).

Maintenance of the system: Cleaning of the known systems usually involves a great deal of effort. For example, in the case of melt bath impregnation, the entire system has to be disassembled and cleaned, which is a laborious process. Here, it is not possible to clean the system during the ongoing process (for example, by use of a cleaning granulate).

From A. Lutz and T. Harmia, “Impregnation techniques for fiber bundles or tows”, Polypropylene, Vol. 2, J. Karger-Kocsis, Ed. Dordrecht: Springer Netherlands, 1999, pp. 301-306. Doi: 10.1007/978-94-011-4421-6_43 a system for melt impregnation is known in which the fibers are guided alternately over two impregnation tools made of a metal foam that is permeable to liquid plastic due to its pore structure. During the ongoing process, liquid plastic is injected into the core of the metal foam and transported towards the surface of the metal foam by means of an extruder. Impregnation takes place through contact of the dry fibers with the plastic-wetted metal foam. This method has shown promising results in practice. It is the object of the invention to provide a method and a device for impregnating dry fibers with a highly viscous, thermoplastic matrix.

In a method according to the invention, this object is achieved by guiding the fibers over a curved, perforated metal sheet as an impregnation line while applying a contact pressure, wherein the highly viscous, thermoplastic matrix passes through the perforations of the metal sheet in order to subsequently impregnate the fibers.

As the fibers used in the method according to the invention any organic or inorganic fibers suitable for material reinforcement, for example carbon, glass or polyamide fibers, come into question.

The perforated metal sheet is not flat but is integrated into the impregnation unit in a curved shape. By deflecting the fibers around the perforated, curved metal sheet the required contact pressure between the fibers and the plastic supply can be created. The fibers can be present as a fiber bundle or as a single fiber and move under longitudinal tensile stress over the metal sheet. This results in a sinusoidal contact pressure distribution between the fibers and the metal sheet.

The highly viscous thermoplastic matrix emerges through the perforations and uniformly envelops the fibers.

The advantages of the inventions are as follows:
The material and manufacturing costs are very low (for example, the perforation of the metal sheet can be produced by laser drilling).
Steel sheets can be procured cheaply in very good quality, so that they can withstand the abrasive effect of the fibers for a long time. In addition, edge layer hardening can be carried out to extend the service life of the metal sheet.
The surface roughness of the metal sheet can be adapted to the respective fibers and process parameters in order to preserve the fibers.
The perforation geometry can be flexibly adapted to the respective fiber-matrix combination depending on the matrix viscosity, for example with the help of a numerical flow simulation.
The curved metal sheet requires only a small amount of installation space, thus enabling a compact design of the device.

A preferred embodiment of the invention is that the perforation pattern of the metal sheet is determined by numerical fluid simulation.

By adjusting the hole size, the hole shape and the arrangement of the perforations across the width of the metal sheet depending on the contact pressure, a precise pressure ratio can be set during the impregnation of the fibers.

The object of the invention is achieved in a device according to the invention by the fact that a curved, perforated metal sheet is provided as an impregnation line, over which the fibers can be guided while applying a contact pressure, wherein the highly viscous, thermoplastic matrix can be guided through the perforations of the metal sheet in order to subsequently impregnate the fibers.

According to a preferred further development of the invention, two or more metal sheets are provided instead of one. These can be arranged either next to each other or in a stacked form.

This enables to realize opening contours for the plastic to emerge that would otherwise be impossible to realize or only with a great deal of effort from a manufacturing point of view.

According to an embodiment of this invention, the metal sheets (2) consist of the same material or different materials and/or have different degrees of rigidity and/or have different wall thicknesses.

The metal sheets can be made of the same material or of different materials. By using metal sheets made of materials with different degrees of rigidity, a sealing effect can be created in the contact surfaces with the impregnation tool, for example. The metal sheets can moreover have different wall thicknesses.

One advantageous embodiment of the invention is that a lateral boundary of the impregnation line is provided.

A further development of the invention is that in order to seal the metal sheet against the tool a hinge bolt clamp is provided, which presses the metal sheet against a carrier tool with a curved shape.

This ensures that no plastic can emerge radially.

An advantageous embodiment of the invention is that the hinge bolt clamp is milled out in the center.

Thus, the hinge bolt clamp simultaneously represents a lateral boundary of the impregnation line. Thus, a functional integration of the metal sheet holder and the limitation of the impregnation line can be achieved in one component.

It is known from toolmaking in injection molding technology that sealing of polymer channels is particularly problematic at high operating pressures. The present design solves the problem by applying a pre-tensioning force perpendicular to each contact surface of the impregnation device through which the plastic could emerge. In addition, the impregnation device can be quickly disassembled and is easy to clean. No waste occurs, since impregnation is possible over the entire width of the impregnation line. This enables a simultaneous width calibration of the product. The width of the impregnation line can be adjusted depending on the spreading capacity of the rovings to be processed. This provides a novel, cost-effective device for producing fiber-thermoplastic semi-finished products with adjustable parameters.

According to the invention it is provided that the carrier tool is designed in two parts.

This carrier tool is used not only to hold the perforated metal sheet but also to supply the highly viscous thermoplastic matrix.

To this end, the carrier tool advantageously comprises a matrix supply and a distribution channel connected thereto, on which the curved metal sheet is arranged.

A take-off unit is preferably arranged at the end of the impregnation line, which serves to calibrate the thickness of the fiber-matrix composite. The thickness of the fiber-matrix composite is thus variably adjustable. This take-off unit causes the matrix to be circulated before it leaves the impregnation line, which additionally increases the impregnation performance and the quality of the surface.

In combination with the previously mentioned lateral boundary of the impregnation line, a closed cavity can be created.

In the following, an exemplary embodiment of the invention is explained in more detail with reference to drawings.

### In the Drawings:

FIG. 1 shows a schematic representation of the impregnation process;

FIG. 2 shows the production and functional principle of the curved metal sheet;

FIG. 3 shows a sectional view (XY plane) of the impregnation device;

FIG. 4 shows a sectional view (ISO view) of the impregnation device;

FIG. 5 shows a sectional view (YZ plane) of the impregnation device; and

FIG. 6 shows a sectional view (XY plane) of the impregnation device according to FIG. 3 comprising a take-off unit.

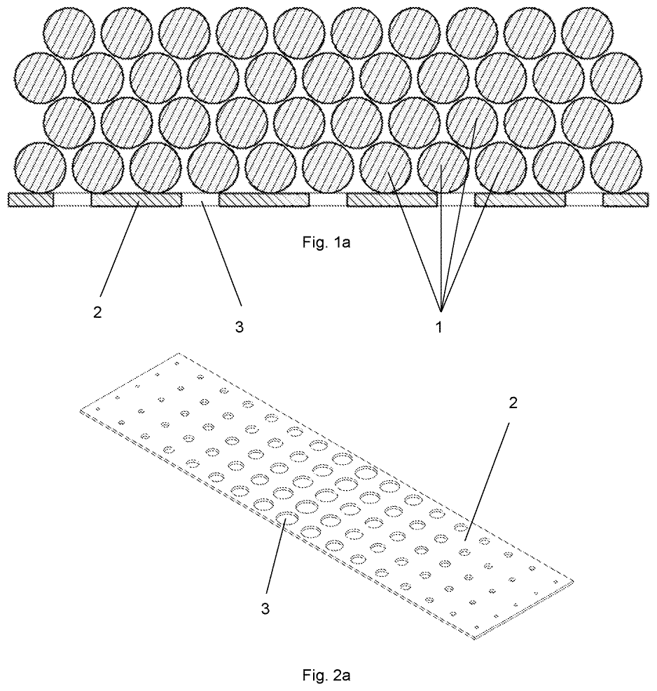

FIG. 1a shows a schematic representation of the impregnation process. The dry fibers 1 move continuously in the direction of the image plane (x-direction) on the metal sheet 2 (shown here in a flat form for simplicity), while highly viscous, thermoplastic matrix, with which the fibers 1 are impregnated, passes through the perforations 3 of the metal sheet 2.

The perforation shown does not correspond to the actual size ratios. The diameter of the individual perforations—depending on the viscosity of the plastic matrix—is between 10 and 500 μm, preferably between 15 and 300 μm and particularly preferably between 20 and 150 μm.

Instead of one metal sheet 2, two or more metal sheets 2 can also be layered on top of each other. This makes it possible to realize opening contours for the plastic outlet that would otherwise be impossible to produce from the manufacturing point of view.

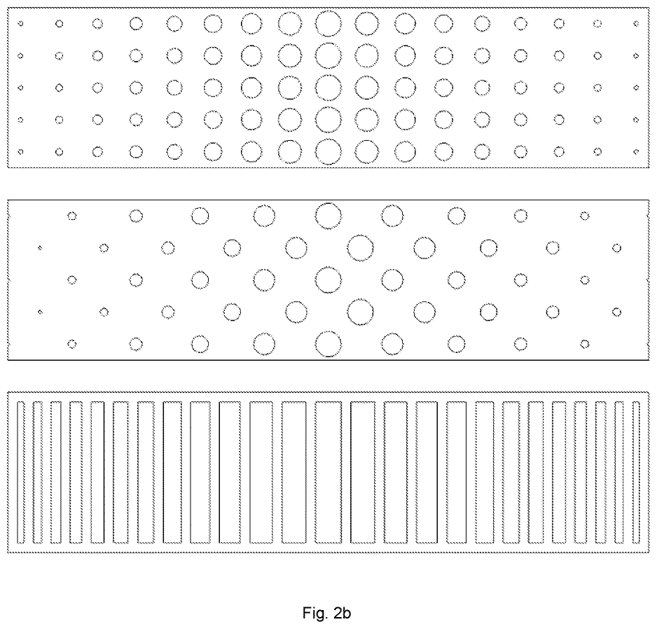

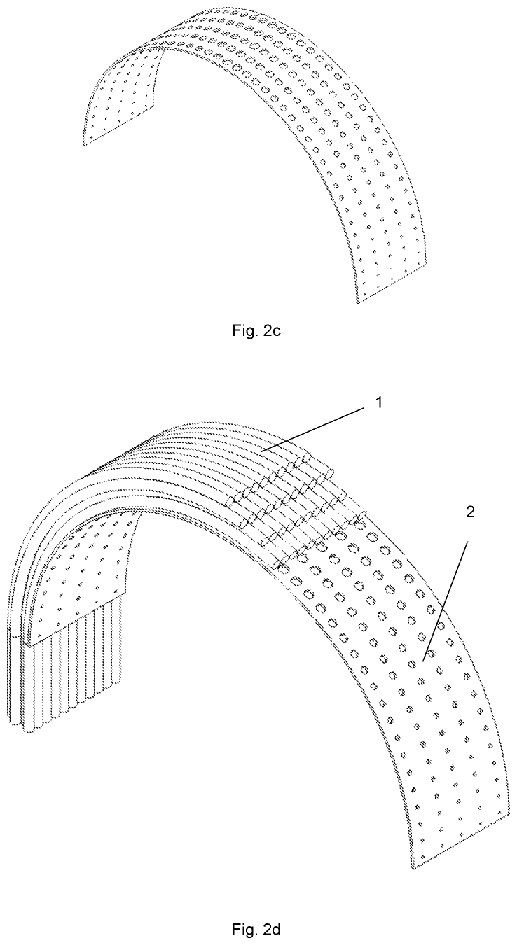

FIG. 2 shows the production and functional principle of the curved metal sheet 2. First (FIG. 2a), a flat perforated metal sheet 2 is produced, wherein the perforation pattern can be adapted to the respective application.

The opening contours in the metal sheet can be circular, rectangular or can have any polygon contour and-corresponding to the sinusoidal contact pressure distribution-can have different dimensions and arrangements on the metal sheet (FIG. 2b).

The impregnation pressure is controlled by the perforation pattern, which is preferably determined by numerical fluid simulation. The metal sheet 2 is then bent into the shape of a circular segment (FIG. 2c), for example by roll bending. FIG. 2d shows schematically the fiber impregnation. The fibers 1 move under longitudinal tensile stress over the perforated metal sheet 2, creating a sinusoidal contact pressure distribution between the fibers 1 and the metal sheet 2. The liquid plastic emerges through the perforations 3. By adjusting the dimension of the perforations 3 depending on the contact pressure, a specific pressure ratio can be set for the impregnation of the fibers 1.

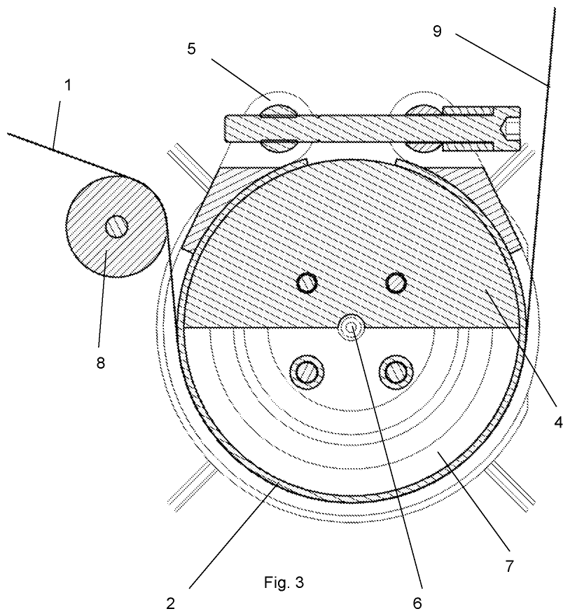

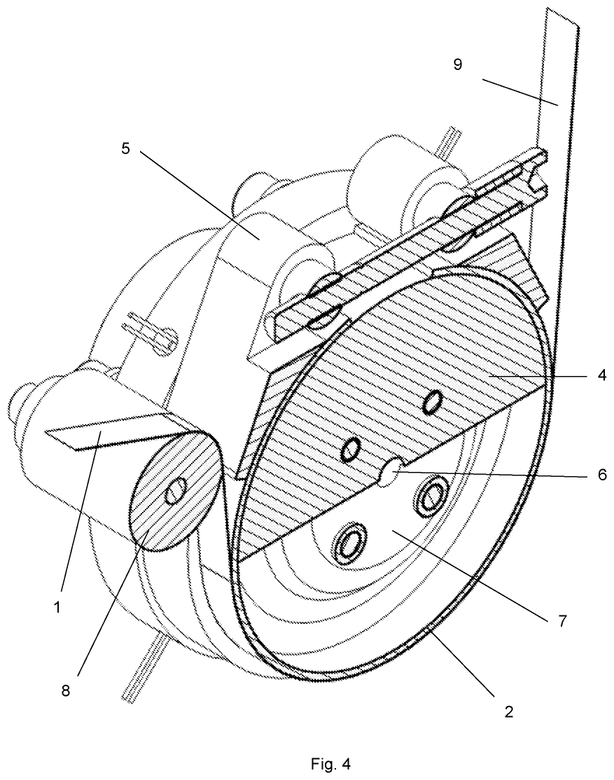

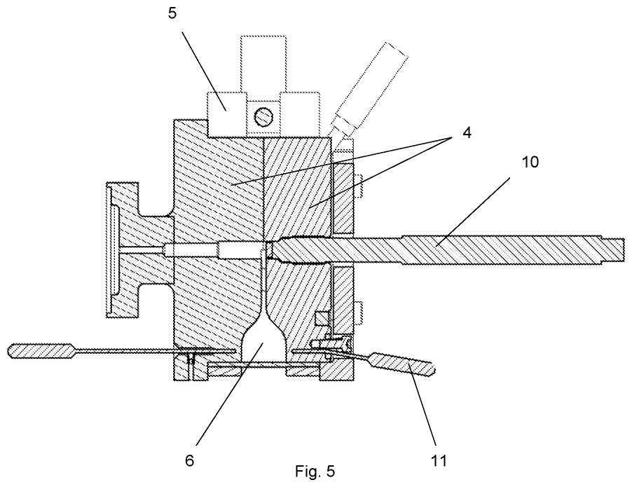

FIGS. 3 to 5 show an impregnation device according to the invention. In order to seal the metal sheet 2 against the carrier tool 4, a specially developed hinge bolt clamp 5 is used. This presses the metal sheet 2 against the carrier tool 4, thus ensuring that no plastic can emerge radially. The special feature of this solution is that the hinge bolt clamp 5 is additionally milled out in the center and thus simultaneously represents the lateral boundary of the impregnation line. This allows a functional integration of metal sheet support and limitation of the impregnation line in one component.

The carrier tool 4 is designed in two parts and, in addition to receiving the perforated metal sheet 2, is responsible for supplying the highly viscous thermoplastic matrix. The highly viscous thermoplastic matrix is supplied from an extruder to the carrier tool 4 through a recessed contour of the matrix supply 6 and distributed evenly below the perforated metal sheet 2 via a distribution channel 7. In addition, the carrier tool 4 serves as a receptacle for various sensors (e.g. pressure sensor 10, temperature sensor 11) for controlling the process. The dry fibers 1 are guided onto the carrier tool 4 via a deflection roller 8, then run in a semicircle over the perforated metal sheet 2, wherein they are impregnated with the highly viscous thermoplastic matrix emerging from the perforations 3, and then leave the carrier tool 4 as an impregnated fiber-matrix semi-finished product 9.

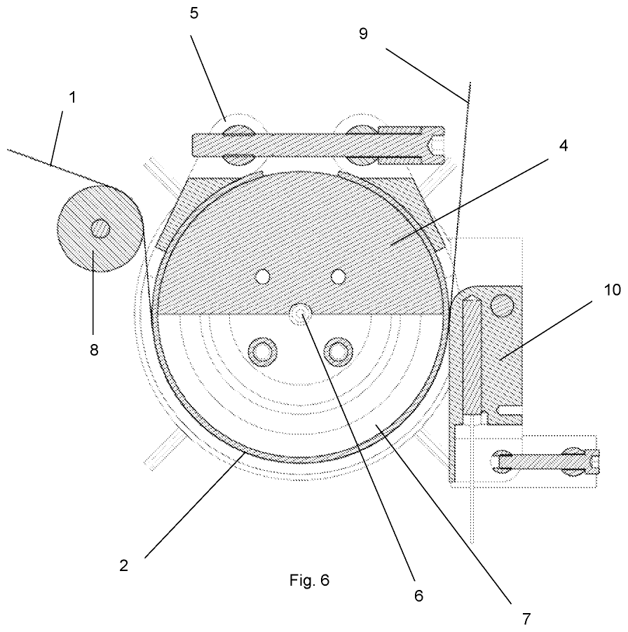

As shown in FIG. 6, at the end of the impregnation line a take-off unit 10 is arranged, which is used to calibrate the thickness of the fiber-matrix composite.

The thickness of the fiber-matrix composite can thus be variably adjusted. This take-off unit 10 causes the matrix to be circulated before it leaves the impregnation line, which additionally increases the impregnation performance and the quality of the surface.

In combination with lateral boundaries of the impregnation line, a closed cavity can be created.

1. A method for melt impregnation of fibers with a highly viscous thermoplastic matrix, wherein the fibers are guided over a curved, perforated metal sheet as an impregnation line, while applying a contact pressure, wherein the highly viscous thermoplastic matrix passes through the perforations of the metal sheet in order to subsequently impregnate the fibers.

2. The method according to claim 1, wherein the a perforation pattern of the metal sheet is determined by numerical fluid simulation.

3. A device for melt impregnation of fibers with a highly viscous thermoplastic matrix, wherein a curved, perforated metal sheet is provided as an impregnation line, over which the fibers are can be guided while applying a contact pressure, wherein the highly viscous thermoplastic matrix is guided through the perforations of the metal sheet in order to subsequently impregnate the fibers.

4. The device according to claim 3, wherein two or more metal sheets are provided.

5. The device according to claim 4, wherein the metal sheets consist of the same material or different materials and/or have different degrees of rigidity and/or have different wall thicknesses.

6. The device according to claim 3, wherein in order to seal the metal sheet against a tool, a hinge bolt clamp is provided, which presses the metal sheet against a carrier tool having a curved shape.

7. The device according to claim 6, wherein the hinge bolt clamp is milled out in a center.

8. The device according to claim 6, wherein the carrier tool is designed in two parts.

9. The device according to claim 6, wherein the carrier tool comprises a matrix supply and a distribution channel connected thereto, on which the curved metal sheet is arranged.

10. The device according to claim 3, wherein a lateral boundary of the impregnation line is provided.

11. The device according to claim 3, wherein take-off unit is arranged at the end of the impregnation line.
